(19) United States
(12) Patent Application Publication
(10) Pub. No.: US 2007/0121587 A1
(43) Pub. Date: May 31, 2007

(54) Package for MCGP for cost and quality control in a VoIP system that simplifies fax/modem/TTY call setup

(75) Inventors: Satish Kumar M. Mundra, Germantown, MD (US); David A. Lide, Rockville, MD (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/288,706

(22) Filed: Nov. 28, 2005

(51) Int. Cl. H04L 12/66

(52) U.S. Cl. 370/352

(57) ABSTRACT

A package under MGCP protocols for providing control over cost and quality of voice calls on an IP-based network such that an optimal selection of connection parameters under given network conditions can be made by a call agent. A gateway transmits an event to the call agent, which in turn changes a call parameter or modifies a connection option for the call.

### CROSS-REFERENCE TO RELATED APPLICATIONS

None

### FIELD OF THE INVENTION

The present invention relates to improving the cost-efficiency and quality of speech transmissions over packet networks, such voice over Internet Protocol (VoIP).

### BACKGROUND OF THE INVENTION

In typical telecommunications systems, voice calls and data are transmitted by carriers from one network to another network. Networks for transmitting voice calls include packet-switched networks transmitting calls using voice over Internet Protocols (VoIP), circuit-switched networks like the public switched telephone network (PSTN), asynchronous transfer mode (ATM) networks, etc. Recently, voice over packet (VOP) networks are becoming more widely deployed. Many incumbent local exchange and long-distance service providers use VoIP technology in the backhaul of their networks without the end user being aware that VoIP is involved.

Organizations around the world want to reduce rising communications costs. The consolidation of separate voice and data networks offers an opportunity for significant cost savings. Organizations are pursuing solutions which will enable them to take advantage of excess capacity on data networks for voice and data transmission, as well as utilizing the Internet and company Intranets as alternatives to costlier traditional mediums. A Voice over Packet (VOP) application can combine legacy voice networks and packet networks by allowing both voice and signaling information to be transported over the packet network. VOP applications require real-time software and hardware modules that can be dynamically configured to provide flexibility and scalability in communication systems with well defined Application Programming Interfaces (APIs). Because of cost savings and other advantages such as accessibility of a large number of users, VOP typically runs over the Internet or a privately managed national or international network.

Digitization and transmission of voice first occurred in the 1950s with the advent and use of solid state electronics. The first commercial usage of a digitized voice carrier was in 1962 when Bell System installed and operated a T1 carrier system for use as a trunk group in the Chicago exchange. Digital speech encoding converts speech into digital forms suitable for transmission on a digital network and decoding reverses the process at the receiving end of the network. Two primary techniques are waveform coding and vocoding. Waveform coders are found in traditional voice networks and ATM and are primarily encoding/decoding algorithms mainly performing input waveform reproduction as accurately as possible with little or no knowledge of the type of signal being processed. Vocoders (voice coders) specifically encode/decode speech signals only. Vocoders encode the perceptually important aspects of speech while using less bits than waveform coders. Therefore, vocoders can be used in networks where less bandwidth is available for voice transmissions. Devices that perform speech digitization are called “codecs”, for coder/decoder. A network with sending and receiving coders include an analog-to-digital (A/D) converter to digitize speech, an analysis module to prepare the digitized speech for transmission, synthesis modules to decode a received digitized transmission, and a digital-to-analog (D/A) converter to change the signal from digital back to analog speech for playout to the human ear. Pulse code modulation (PCM) is currently the most popular application for digitizing speech. Coder/decoder systems attempt to reduce the data rate and are therefore lossy, which lowers the quality of the transmission. Examples of various encoders include logarithmic PCM, adaptive delta modulation, sub-band coder, adaptive differential PCM (ADPCM), adaptive predictive, channel vocoder, linear predictive coding, and formant vocoder.

In the mid-1990s the ITU-T standardized vocoders that are applicable to VoIP applications. A sample of ITU-T speech coding standards are G.711 (64 kbps PCM with A-law and u-law), G.722 (64, 56, or 48 kbps wideband vocoder), G.726 (ADPCM vocoder), G.727 (40, 32, 24, or 16 kbps Embedded ADPCM), G.728 (16 kbps low delay code excited linear prediction vocoder), G.729 (8 kbps conjugate structure algebraic code excited linear prediction (CS-ACELP)), G.723.1 (5.3, 6.3 kbps multi-rate encoder for multimedia communications).

Many manufactured products for transmitting voice and video were based on proprietary methods that limit interoperability. In an attempt to standardize voice, video, and data communications over the Internet, the ITU-T H.323 was drafted to standardize terminals, equipment, and services for multimedia transmissions over LANs and IP networks which do not have guaranteed QoS. H.323 uses standards G.711, G.722, G.278, G.729, and G.723 audio and speech codex as part of the multimedia standard. Internet Engineering Task Force (IETF) has also produced protocol and message transfer standards in Request For Comments (RFCs) for audio and multi-media communications over a network. These standards include Session Description Protocol (SDP) in RFC 2327, the Session Announcement Protocol (SAP) in RFC 2974, the Session Initiation Protocol (SIP) in RFC 3261, and the Real Time Streaming Protocol (RTSP) in RFC 2326.

The goal of any voice codec and transmission process obviously is a faithful reproduction of the original speech. The optimal speech quality is “toll quality” or the quality of a call made over the traditional public switched telephone network (PSTN). Quality of voice transmission is compromised by the quantization process, noise, or quality of service (QoS) problems in an IP network such as packet transmission delay and jitter. Quantization is the process of mapping amplitudes of analog speech into discrete digital values which results in a loss of information. Quality is impacted by both the codec and compression methods together with QoS of the Internet. Delay in signals causes two problems, echo and talker overlap. Echo is caused by the signal reflections of the speaker's voice from the far end telephone equipment back into the speaker's ear. Talker overlap becomes significant if the one way delay becomes greater than 250 ms. Accumulation delay, or algorithmic delay, is cause by the need to collect a frame of voice samples to be processed by the voice coder. Processing delay is caused by the actual process of encoding and collecting the encoded samples into a packet for transmission over the packet network. Network congestion on the Internet negatively affects quality of service for voice transmissions, as well as the ability of switches to perform real-time IP switching. Network delay is caused by the physical medium and protocols used to transmit the voice data, and by the buffers used to remove packet jitter on the receive side. Jitter is a variable inter-packet timing caused by the network a packet traverses. Removing jitter requires collecting packets and holding them long enough to allow the slowest packets to arrive in time to be played in the correct sequence. Lost packets is an even more severe problem, depending on the type of packet network that is being used. Because IP networks do not guarantee service, they will usually exhibit a much higher incidence of lost voice packets than ATM networks.

Broadband access devices such as cable modems or digital subscriber line (DSL) modems are increasingly expected to provide IP telephony services in addition to high-speed data. They are typically expected to have two or more RJ11 ports for telephony services that would accommodate either two telephone extensions or a telephone and fax machine. For the end user, the telephony/data ports are expected to look and act similar to a standard analog telephone line for use in making local and long-distance telephone calls as well as for sending fax transmissions.

When placing a VoIP call, there is typically an original VOP codec limitation that is negotiated at the beginning of the call and cannot be changed during the transmission. Both ends of a VoIP call must use the same codec. Codecs can either be manually selected by users through specialized software, or a default codec may be used in a VoIP managed network that is out of control of the end user. One codec may not be ideal for all telephony devices and network conditions. For example, changing network conditions such as packet propagation delays may cause a sudden need for greater processing power and bandwidth during a call. A user on a VoIP call may simply desire to decrease the quality of a call to save costs or to increase quality for clearer speech transmissions during a call. Changing the codec based upon the user's intentions while a call is in progress would include the option to change the codec in real-time.

Factors that affect voice quality in a VoIP network are fairly well understood. The level of control over these factors will vary from network to network. This is highlighted by the differences between a well-managed small network enterprise verses an unmanaged network such as the Internet. Network operational issues affect network performance and will create conditions that affect voice quality. These issues include outages/failures of network switches, routers, and bridges; outages/failure of VoIP elements such as call servers and gateways; and traffic management during peak periods and virus/denial of service attacks.

### SUMMARY

During a voice over packet call, the choice of codec used for initially establishing the call depends upon the codecs that are supported at sending and the receiving telephony devices. Both the sending and receiving devices must use the same codecs during speech transmissions to take advantage of the lower transmission rates and higher quality transmissions offered by specialized codecs for speech over packet networks. Users of an IP telephony system may subscribe to a service where lowering the cost of the voice call is the default policy, and therefore the lowest cost codec is present for the users.

However, after placing a call and speech is being transmitted, a user at one end may desire a higher quality call through either a better network managed network connection or a better codec, which may not correspond to the lowest cost transmission. Support for such a change in codec is generally absent from signaling protocols, such as media gateway control protocol (MGCP), except for the case when a switch over to basic PCM is desired when the call is being established and the call is formatted for modem or facsimile transmissions.

Other dynamic network constraints on the choice of codec include available bandwidth, available processing power, and other network interference conditions such as delay, loss, and jitter. The dynamic constraints in the network may change during the course of call transmissions. For example, a conversation may begin on a high-quality bandwidth connection that has little delay and few lost packets, but as the call progresses, the call quality degrades significantly due to network traffic causing delay, echo, lost packets, or other propagation problems. Significant benefits in terms of cost or quality are derived if a user has the ability to change a codec at will during a call transmission depending on changes in either network conditions, cost considerations, or desired call quality.

The present invention provides a mechanism in software such that a user and/or a VOIP gateway can control the cost and quality of VOIP calls. The present invention further provides an alternate mechanism in software for support of fax, modem and TTY calls over a packet network. A gateway generates an event where a desired codec and/or connection options can be specified. An advantage is that bandwidth utilizations are improved, thereby lowering costs. A further advantage is that it provides control to a user to optimize the performance of VOIP calls.

### BRIEF DESCRIPTION OF THE DRAWINGS

For a better understanding of the nature of the present invention, its features and advantages, the subsequent detailed description is presented in connection with accompanying drawings in which:

FIG. 1 is a diagram of a packet network using voice over Internet Protocols (VOIP);

FIG. 2 is a network diagram illustrating gateway devices implementing the signaling protocol of the preferred embodiment;

FIG. 3 is a flowchart diagram using signaling to determine ADPCM interoperability between an originating intelligent gateway and a terminating legacy gateway;

### DETAILED DESCRIPTION OF THE INVENTION

There is described herein a technique to lower the cost and improve the quality of voice calls over IP networks by providing users the ability to select an appropriate codec during a voice over IP call. The invention gives users real-time control over the cost and quality of the voice call by monitoring the dynamically changing resources and network conditions on an IP network and allowing users to select appropriate codecs before and during the call.

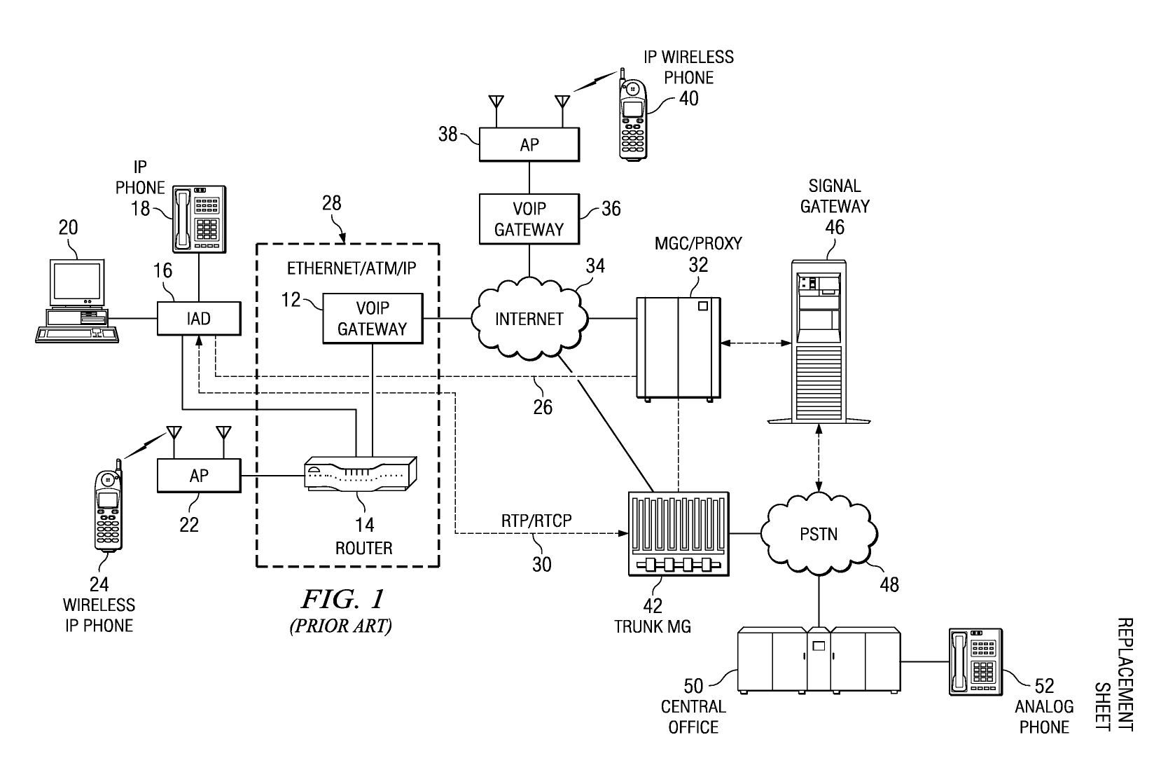

A typical voice over Internet Protocol (VOIP) network is illustrated in FIG. 1. The network is a communication network that could be any managed network such as a packet network, Broadband IP network, Asynchronous Transfer Mode (ATM), Ethernet network, etc. The communications network comprises a router 14 connected to various customer premise equipment and a VOIP gateway 12. Gateways generally can monitor and detect events affecting a VoIP call that include available network bandwidth, processing power, delay, and jitter. The gateway monitors bandwidth for all calls terminating at gateway 16 and will detect packet loss resulting from congestion.

VOIP gateway 12 must be capable of detecting changing resource or network conditions and specializes in the transmission and reception of encoded audio signals. The ability to detect and monitor changing resource and network conditions can result in significant cost reductions and/or improved quality. Router 14 is connected to Internet Access Device (IAD) 16, wireless access point (AP) 22, and/or IP PBX (personal branch exchange) 23. A voice call may be placed between any of the customer equipment phones 18 connected to IAD 16 or wireless IP phone 24. Using special software, calls could also be placed through computer 20 connected to IAD 16.

Customer equipment is connected through access broadband network 28 to the Internet 34 by VOIP gateway 12. On the far end is the PSTN 48 connected to POTS phone 52 through a Central Office 50. PSTN 48 is also connected to the Internet 34 through a media gateway. A media gateway (MG) can be defined as one or more network hardware devices that convert audio (e.g., voice and background) signals between the PSTN 48 and a packet network, such as Internet 34. The MG can be divided into separate functional units as well as physically separate units. In the exemplary network diagram in FIG. 1, a classic MG is divided into three units, trunk MG 42, media gateway control/proxy 32, and signal gateway 46. The trunk MG provides an interface between PSTN 48 and VOIP network 28, which effectively includes Internet 34.

IP and packet data (e.g., real time protocol (RTP packet data)) associated with the call is routed between IAD 16 and trunk MG 42. The trunk gateway system provides real-time two-way communications interfaces between the IP network (e.g., the Internet) and the PSTN 48. As another example, a VoIP call could be initiated between WIPP 24 and WIPP 40 connected to AP 38. In this call, voice signals and associated packet data are sent between MG 12 and MG 48 through Internet 34, thereby bypassing the PSTN 48 altogether.

The present invention comprises a software package for a communications network, such as the VOIP network in FIG. 1, that uses a signaling to change local connection options for a call. The preferred embodiment uses a Media Gateway Control Protocol (MGCP) that defines the signaling interface that is uses to modify the local connection options. MGCP MCGP is a protocol used in media gateways, such as VOIP gateways. MCGP assumes most of the operational intelligence for call control through gateways. MCGP operates under the assumption that Call Agents on a network will cooperate with each other to receive and respond to commands from gateways. A gateway executes the commands that are sent to it from a Call Agent. A network using MCGP uses endpoint connections may be either point to point or multipoint for completing calls. MGCP can be established in the transmission of voice packets using RTP an UDP in IP networks and using AAL2 over ATM networks. One skilled in the art will also recognize that the present invention could also use the MEGACO media gateway control protocol) protocol, which was developed by the Megaco Working Group of the Internet Engineering Task Force and published as RFC 3015 (and also published as ITU-T Recommendation H.248) in cooperation with ITU-T Study Group 16.

Control over a call is handled outside of the originating and terminating gateways with the MGCP package called “Call Agent.” “Events” and “packages” are used in MCGP to manage the call connections and related operations. An event is defined as something that occurs at a network endpoint, such as off-hook and on-hook events. A group of events is a “package.” Packages are defined according to associated signals used for a call. Examples of MCGP packages are DTMF (Dual-Tone Multi-Frequency), Generic Media, Handset Emulation, RTP, and Network Access Server.

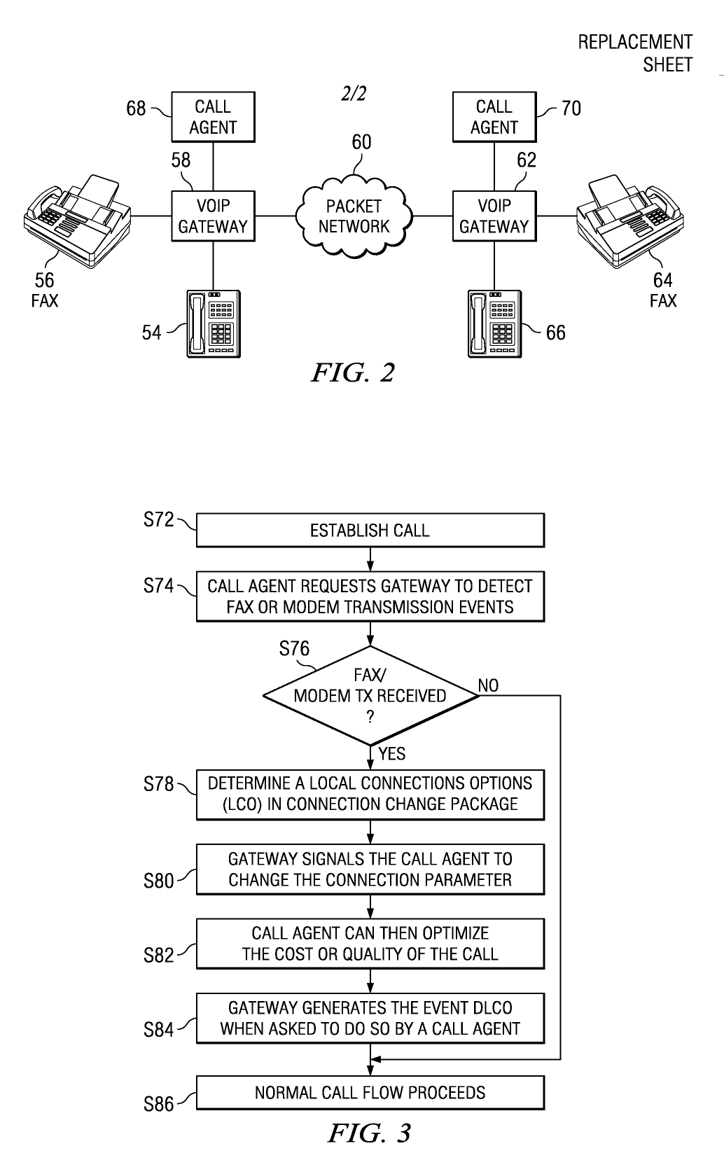

FIG. 2 illustrates a diagram of an exemplary network connecting two VOIP telephony devices. The network includes a packet network 60 between a first IP telephony device 54 on one end and a second IP telephony device 66, such an IP phone, on the second end. Packet network 60 may include a managed broadband IP network and/or the Internet. A first VOIP Gateway 58 supports packetized audio calls with a second VOIP gateway 62 and monitors network conditions within managed network 60. Gateways 58, 62 also support packetized facsimile transmission between a first facsimile device 56 and a second facsimile device 64. Two Call Agents 68, 70 are located on the network. A first Call Agent 68 sends commands to VOIP gateway 58, and a second Call Agent 70 sends commands to VOIP gateway 62.

In the preferred embodiment, either gateway 58, 62 or a user of the communication network may wish to change a codec, a packetization period, or other call parameter in order to optimize a cost or quality criteria of the call. For example, a user may subscribe to an Internet telephony service where lowering the cost is the default policy at both gateways and IP telephony network provider. A user may also desire a higher quality, or lower quality, codec during transmission for reasons unrelated to call quality or cost. The desired codec may or may not be the codec of lowest cost. Dynamic codec changes are supported within gateways and call control protocols.

There are many reasons for changing the call parameters such as the codec or packetization period for a voice call. Packet loss in the media stream could signal network congestion and may result in selection of a low bit rate codec for affected calls or interchange the codec with another call that may not be experiencing such losses. The availability of greater bandwidth could also result in changing to a high bit rate codec, if so desired by the user. The packet size and VAD (voice activity detection) can be changed, enabled, or disabled to improve quality or reduce costs of the call. Packet loss bandwidth resource reservation authority may be queried for detecting bandwidth availability, or a dummy reservation may be attempted to secure available bandwidth. Real-time control protocol (RTCP) could also be used to monitor network conditions and generate this event. Other reasons include gateways 58, 62 may not have processing resources available to honor a preferred codec when a call is being established. However, the gateways 58, 62 could be in a position to switch to a desired or codec that would result in a better call quality at a time after a call is established. A gateway using RTCP feedback or other similar mechanisms may determine the optimal codec and connection options (i.e. packetization period, silence suppression, etc.) that satisfy the user's criteria for desired cost and quality of a call. A gateway may also be made aware of fax or modem devices attached to its endpoints. The preferred embodiment takes advantage of this knowledge by starting a call with suitable connection options for in-band transmission or by selecting codecs that support modem/fax relay.

A user could define protocols to automatically have agent change the codec, such as lowest cost, highest quality, or highest bandwidth. The improved quality could result in additional costs, however the change is controlled by the user and conditionally generated only upon the user's command. A user may also decide to override default choices of codec or cost parameters for a particular call or class of calls.

The preferred package provides mechanisms for MGCP call agents and gateways to support and optimize voice band data transmission. It provides controls over cost and quality of voice calls and provides optimal selections of connection parameters under given network conditions that affect voice quality such as jitter, delay, bandwidth availability, and packet loss. A Call Agent may use a preferred codec for a user based on the default polity subscribed to by the user for the current call or a class of calls. The Call Agent could make the selection by considering the cost and quality desired in the policy subscribed by the subscriber.

Referring contemporaneously to the flowchart in FIG. 3, once the call is established S72, the parameters are normally left in place for the duration of the call for a voice call. The following operations are described using originating gateway 58 and Call Agent 68, however it is understood that the methods and systems described herein could apply to terminating gateway 62 and Call Agent 70. If gateway 58 and Call Agent 68 support packages for fax/modem relay or in-band transmission, then the call parameters would be changed. To enable this procedural change of call parameters, Call Agent 68 requests gateway 58 to detect appropriate events S74 so that the gateway can determine if fax or modem transmission is going to occur. If the fax or modem transmission occurs S76, the gateways can change the call parameters appropriately using the procedure described in the preferred method below.

A connection change package can be defined for the preferred embodiment as follows:
Package Name: LS
Package Version: 0

The preferred package determines a “localCOnnectionsOptions” (LCO) S78 that a gateway desires to use for a next subsequent call that originates from an endpoint and sends the LCO command from the gateway to the Call Agent. The preferred package allows a gateway to signal the Call Agent S80 a desire to change the connection parameter anytime after a call is connected. The Call Agent can then optimize the cost or quality of the call S82 as desired by a user or preset by the gateway by modifying the call connection at both ends and perform appropriate changes to the bandwidth reserved for the call.

In order to execute the preferred package, the following events are defined as part of the package:

| | | | |
|---|---|---|---|
| Symbol | Definition | R | S Duration |
| dlco | Desired LCO | x | |

In addition, a desired LCO (dlco) event is defined where Call Agent can ask for event dlco to be detected at any time. An example of this message is the following:
R: hd (A, E( R(LS/dlco, hu, [0-9]#T(D)), S(dl) ))
R: LS/dlco, hu

A gateway generates the event dlco when asked to do so by a Call Agent S84. The event can be parameterized with a desired LCO as shown in the examples below. A gateway that specifies the desired LCO for an existing connection also specifies the connection identifier for the connection that is to be modified. The modification of the connection identifier is performed using the “@” notation, which is used for signals that are applied or detected on a connection. If no connection identifier is specified, then the gateway desires to execute the specified LCO for all existing connections on the endpoint or on any new connection on the endpoint. Once the specified LCO is executed, the call proceeds with normal call flows S86.

The exemplary messages for the desired event dlco are as follows:
NTFY 1001 aaln/1@whatever.net MGCP 1.0
X: 12345
O: LS/dlco@123 (p:20, a:G728, s:off)

An exemplary MDCX from Call Agent may appear as the following:
MDCX 2001 aaln/1@whatever.net MCGP 1.0
C: ABCDEF
I: 123
L: p:20, s:off, a: g728

In a further example, the following notification would result in a CRCX from the Call Agent specifying t38 as the codec. The generation of this NTFY (notify) would imply that either the gateway has knowledge that a fax machine is attached on the endpoint or that it has made this decision on the basis of tones detected from the endpoint.
NTFY 1002 aaln/1@whatever.net MGCP 1.0
X: 123456
O: LS/dlco@123 (a: fxr/fx:t:38; PCMU, s:off)

An exemplary CRCX from Call Agent to an endpoint is the following:
CRCX 3001 aaln/1@whatever.net MCGP 1.0
C: 0123456768
L: a: fxr/fx:t:38;PCMU, p:20, s:off, e:off

The format for the parameterized LCO is a similar format for LocalCOnnectionsOptions in CRCS or MDCX, and the same rules apply. For LocalCOnnectionsOptions missing the desired LCO, a Call Agent would assume that those parameters require no change of that it is free to choose as if non existed for the call.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A method to optimize call parameters for calls on an Internet Protocol-based network, comprising:
providing a call agent, connected to a gateway on said network;
executing a Media Gateway Control Protocol (MGCP) connection change package on said call agent;
transmitting a LocalCOnnectionsOptions (LCO) event, from said gateway to said call agent, that includes a notice to change a call connection parameter;
receiving, by said call agent, said LCO event; and
changing, by said call agent, said call connection parameter.

2. The method of claim 1, wherein said transmitting comprises transmitting said LCO event to said call agent that includes a notice of a fax or modem device that is connected to an endpoint of said network, and
said changing comprises said call agent selecting a codec for said gateway that supports a modem or fax relay.

3. The method of claim 1, wherein said transmitting further comprises transmitting a desired LCO (dlco) event from said gateway to said call agent after said gateway receives a request for said dlco by said call agent.

4. The method of claim 3, further comprising:
parameterizing said dlco event by said gateway specifying a connection identifier for an existing call connection on said network using an “@” notation according to MGCP protocols.

5. The method of claim 1, wherein said changing comprises said call agent modifying a connection of said call at each endpoint of said call, and
modifying a bandwidth reserved for said call between each endpoint.

6. The method of claim 1, wherein the method is performed according to MEGACO protocols.

7. A system to optimize call parameters on an Internet Protocol-based network, comprising:
a gateway, connected to a call agent module, connected between two endpoints on said network, wherein
said call agent and said gateway executes a Media Gateway Control Protocol (MGCP) connection change package that transmits a LocalCOnnectionsOptions (LCO) event, from said gateway to said call agent, that includes a notice to change a call connection parameter, and
said call agent changes said call connection parameter in response to said LCO event.

8. The system of claim 7, wherein said gateway transmits said LCO event to said call agent that includes a notice of a fax or modem device that is connected to one of said endpoints of said network, and
said call agent selects a codec for said gateway that supports a modem or fax relay.

9. The system of claim 7, wherein said gateway further transmits a desired LCO (dlco) event from said gateway to said call agent after said gateway receives a request for said dlco by said call agent.

10. The system of claim 9, wherein said gateway further transmits a parameterized dlco event that specifies a connection identifier for an existing call connection on said network by using an “@” notation according to MGCP protocols.

11. The system of claim 7, wherein said call agent modifies a connection of said call at each endpoint of said call, and
modifies a bandwidth reserved for said call between each endpoint.

12. The system of claim 7, wherein the call agent operates according to MEGACO protocols.
